(19) United States
(12) Patent Application Publication
(10) Pub. No.: US 2020/0281187 A1
(43) Pub. Date: Sep. 10, 2020

(54) Safety bait applicator

(71) Applicant: Clayton E. Schulze, Albion, PA (US)

(72) Inventor: Clayton E. Schulze, Albion, PA (US)

(21) Appl. No.: 16/501,163

(22) Filed: Mar. 4, 2019

(51) Int. Cl. A01M 25/00

(52) U.S. Cl. CPC A01M 25/004; A01M 23/00

(57) ABSTRACT

A bait station for feeding toxic bait to pest and rodents. The Safety Bait Applicator is generally enclosed structure having two open entrances where a pest rodent can enter and feed on the toxic bait chunks. The bait chunks are held in the center of the special designed tee area that prevents the pests from removing the toxic bait chunks from the bait station. See drawings A. and B. FIG. 5. for illustrations of the how the bait chunks cannot pass through the openings.

Bait Applicator for Rodents:

Unit will consist of pipe or tubing and size in diameter and length may vary depending on the bait and the quantity and size of the rodent or given consumer.

The longest part of the safety bait applicator is for storing the bait and should be fixed in a vertical position so gravity will move the bait down into the bottom pipe which is accessible to the rodent consumer.

Once the safety bait applicator is filled with bait a cap is placed over the top end of the “Safety Bait Applicator” to keep out rain if used outdoors. The cap also keeps the bait inside the “Safety Bait Applicator”.

Special made tee so the vertical pipe inserts into the bottom horizontal pipe to approximately ¾ of an inch from the bottom which prevents the bait chunks from falling out of the bait tube should it fall over. Rodents enter the horizontal bottom pipe on either side.

To use the “Safety Bait Applicator”, remove the top cap, insert bait chunks into vertical pipe. Replace the cap and install the “Safety Bait Applicator” in a vertical position so rodents can enter the bottom or horizontal pipe.

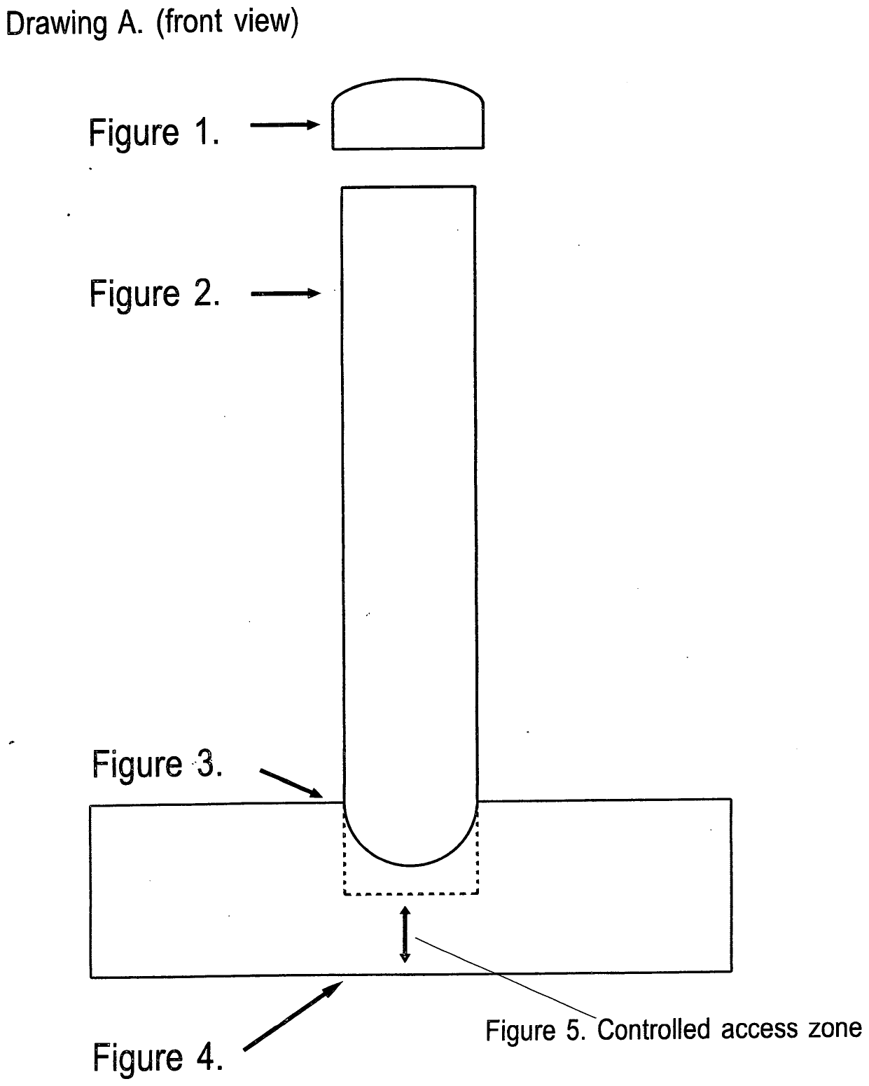

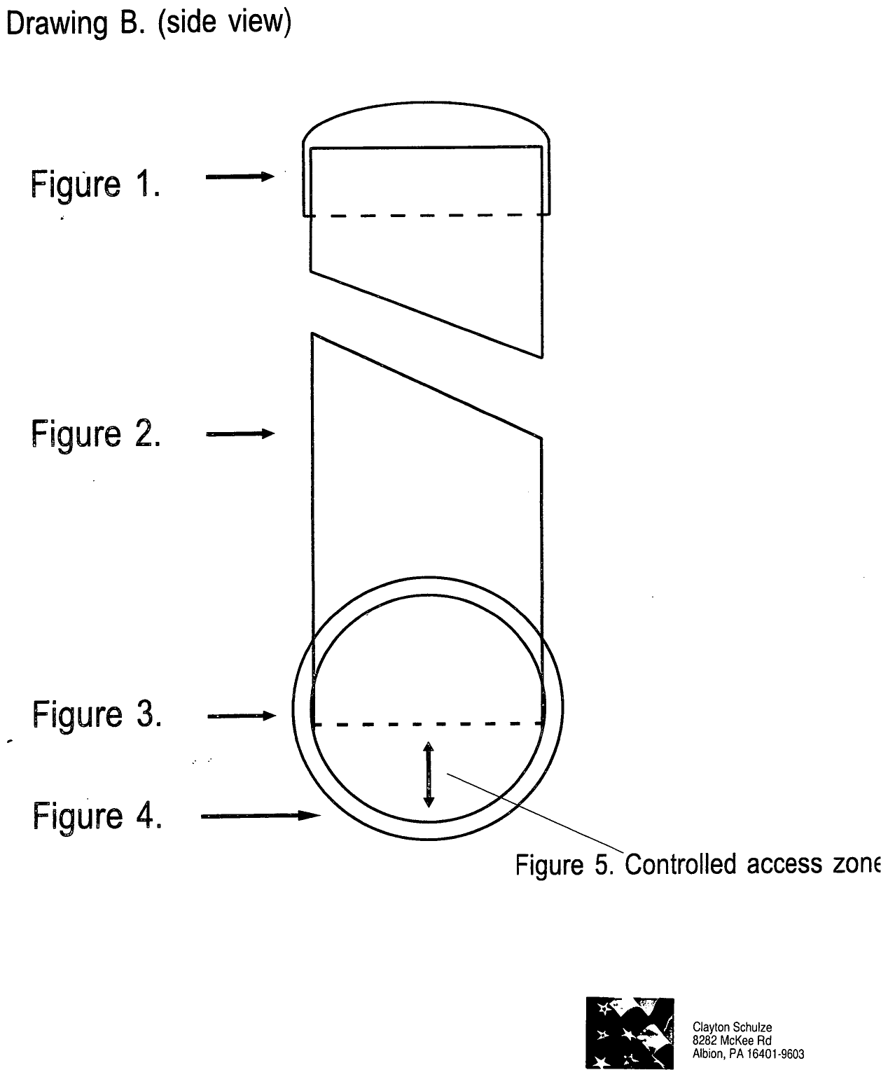

1. Safety Bait Applicator comprising of one vertical conduit and one horizontal conduit as seen in drawings A. and B. The conduits are connected in the center of the horizontal conduit by a Special Designed Tee which connects the two conduits. The Special Designed Tee controls the opening space between the two conduits. The space prevents the bait chunks from falling out should the Safety Bait Applicator accidentally be knocked over. The space can be seen in drawings A. and B. FIGS. 3. and 5.
The vertical conduit is the reserve or storage area of the pest bait chunks. The vertical conduit may vary in lengths which will allow different storage amounts. The reserve may vary in length of 2 to 4 feet long or more. See drawings A. and B. FIG. 2.
FIG. 5 on drawing A. and B. shows the space between the vertical supply conduit and the horizontal pest entrance conduit. This space inside of the special designed tee is critical in keeping the bait in the conduit to target specific rodents.
